(19) United States
(12) Patent Application Publication
(10) Pub. No.: US 2008/0256510 A1
(43) Pub. Date: Oct. 16, 2008

(54) Method And System For Generating Automatically Distributable Clients Of Application Servers

(76) Inventor: Alexander Auerbach, Berlin (DE)

Correspondence Address: ST. ONGE STEWARD JOHNSTON & REENS, LLC, 986 BEDFORD STREET, STAMFORD, CT, 06905-5619, US

(21) Appl. No.: 12/105,000

(22) Filed: Apr. 17, 2008

Related U.S. Application Data
(63) Continuation of application No. PCT/EP2006/009804, filed on Oct. 11, 2006.

(30) Foreign Application Priority Data
Oct. 17, 2005 (DE) 10 2005 050 304.7

(51) Int. Cl. G06F 9/44

(52) U.S. Cl. 717/107; 717/106

(57) ABSTRACT

A process is disclosed for generating clients for distributed applications, in which a server part is implemented by an application server. These clients automatically locate and use the services carried out and offered over a network by a specific installation of an application server. The generated clients can thus be easily distributed and operated in a network. A system is further disclosed for implementing the process and generating clients during the installation of distributed applications.

### CROSS-REFERENCE TO RELATED APPLICATIONS

The present application is a continuation of pending International patent application PCT/EP2006/009804 filed on Oct. 11, 2006 which designates the United States and claims priority from German patent application 10 2005 050 304.7 filed on Oct. 17, 2005, the content of which is incorporated herein by reference.

### FIELD OF THE INVENTION

This invention relates to the solution of information technology tasks with the help of application servers. More specifically, it relates to a process and system for generating clients for distributed applications whose server part is implemented by an application server. These clients automatically locate and use the services carried out and offered over a network by a specific installation of an application server. The generated clients can thus be easily distributed and operated in a network.

### BACKGROUND OF THE INVENTION

The solution of information technology problems increasingly demands the cooperation of mutually networked systems. This requires mastering increasing complexity, which arises not only from increasingly complex challenges but also from the rising technical expenditure for the efficient realization of the distribution and communication of the individual parts of solutions.

To master this complexity, middleware and application servers based on it are among the resources applied. In this manner one simplifies the development of the parts of a solution that affect communication between the parts of applications in a network.

By the way of background, the technical basis of application servers is middleware. Middleware allows processors that belong to a distributed application to be available for the run time of reciprocal services. The concept of the service thus enables a simple description of the interactions between parts of applications.

A service is usually described by one or more interfaces, that is, a defined number of operations. This description normally allows no inference concerning the concrete implementation of the service. Thus, implementations can be exchanged without modification of other parts of the application that use the particular service. The condition for this is that the modified implementation performs a service with the same interface in the simplest case the interface of a service consists of just one operation.

The code required for providing and using services over a network is either produced with middleware by tools from a description of the service or provided as a standardized partial solution. A middleware is produced either by the tools and language for describing services or by the code of the standardized partial solution. Both the code of the standardized partial solution and the code produced by a tool from an abstract description are designated hereafter as middleware code.

Technically, middleware produces a multiplexer over a simple, bidirectional communication channel as a network provides it between two or more systems. For this purpose, middleware code communicates between the application-specific code and the network.

Middleware code is thus necessary both for the program that provides a service, which is called a service server, and for the program that uses a service and is called a service client. Because this distribution of roles of the program refers to a concrete service, a program can be related to a service server and to a service client.

The use of a service with middleware occurs over a network, so that the service server and service client can be executed by various systems. The communication between them occurs in run time by the reciprocal addressing of data packets. The middleware code of the service client automatically provides information on the used service and the operation to the data packet that is to be transmitted over the network, in addition to the parameters of the operation.

The middleware code of the service server uses this information in order to automatically execute the code of the operation of the designated service with the transmitted parameters. If this application-specific code provides a result, then it is automatically sent back by the middleware code of the service sender to the service client. The middleware code of the service client then turns over the result to the application-specific code that uses the service.

The application-specific code, which implements the service, must be registered with the middleware code of the service server so that it can be executed. If the service server is software, then it can occur for instance with callback functions, which serve as entry point into the application-specific software code. On the other hand, if dealing with hardware, the middleware code can provide signal lines, or busses to which application-specific integrated circuits can be connected.

Services can be produced by middleware in various ways, but in every case must be clearly identifiable by a service client. With simple services that provide only one operation an identification key suffices. If the interface of a service consists of several operations, then the particular operation must also be capable of being clearly identified.

The method or data format with which services and operations are identified by a service client define the particular middleware. Simple middleware, such as remote procedure call (RPC), thus allows a program to provide a series of operations that can be called up individually in run time.

High performance middleware, such as CORBA (common object request broker architecture) or DCOM (distributed component object model), for instance, allows a program to simultaneously provide various services that are described by their own interface.

With middleware, no distinction is made between the various programs involved in a distributed application. Thus, a program can at the same time offer a service and use another client, and is therefore both a service server and a service client. With major problems, however, various demands are often made on the various parts of a distributed application. This results in a specialization of the various programs to server and client programs, called servers and clients for short. Clients have the predominant task of integrating with the user. Servers, on the other hand, primarily provide services that clients use. Thus, a client process is typically used by a single user, while a server process simultaneously makes services available to several client processes.

Application servers provide a layer of abstraction above middleware that is specialized in the development of server programs (see FIG. 1). This increases the scalability of the server program because the close connection of middleware code and application-specific code is increased. With middleware the middleware code and its configuration, which is taken from the application-specific code, predominantly determine the scalability of a server program. Scalability thus designates the number of client processes (1.1) that can simultaneously use the services (1.6) of a server process (1.5). A high scalability means that a great number of simultaneous client processes is supported by the particular server process.

Application servers produce the separation of middleware code and application-specific code by providing each a run time environment (1.3) that can be configured by the user, typically a system administrator, and that contains the middleware code and thus provides usable services over a network. This run time environment can be adapted to the respective run time demands through its configurability. The run time environment also includes infrastructure services, which support the use and supply of services. This can include a name service, for instance.

The application-specific code (1.4), that is, the implementation of the service or services, is supplied to the run time environment in a defined format and is loaded and executed by the environment. Application servers therefore require that the application-specific code must be present as software, contrary to the run time environment itself. The format used is often standardized so that, because of the use of various run time environments specialized in various use scenarios, the scalability of a server program can be adapted to the particular requirements.

Interactions between application-specific code pieces and run time environment are described by interfaces. Contrary to middleware interfaces, the services described by these interfaces can be used only within the process by which the run time environment and the application-specific code is executed.

A run time environment can often simultaneously load and execute several application-specific code pieces. Each code piece thus implements one or more services. The application server provides not just the run time environment, but also necessary tools to be able to produce these application-specific code pieces in corresponding format.

The decisive advantage of application servers over middleware consists thus in their greater flexibility. This is particularly true for the scalability of the distributed application. While the decision on the concrete scaling of an application with middleware must be made during its production, with application servers this decision can also be made in the installation of the solution. In addition, it can also be revised later with relative simplicity, by modifying the configuration of the run time environment or if a different run time environment is used.

Examples of application servers are Web servers, which dynamically produce Web pages. Various standards exist here such advanced server pages (ASP), Java Servlets, or Java server pages (JSP), which each define different requirements for the application-specific code.

A group of application servers that is important for this invention are component-oriented application servers (see FIG. 2). In these servers the application-specific code pieces are components (2.4) that can be combined for form applications. For this purpose the application server provides mechanisms with which the components can offer and use services reciprocally in run time (2.7 or 2.8). This is impossible with non-component-oriented application servers. For example, with Web servers, only Web browsers are foreseen as users of services, but not other code pieces executed by the run time environment.

Because several client processes can simultaneously use the service offered by one component, it is often necessary with condition-dependent components for the component to manage one particular condition for each client process. This makes a conference management necessary that some application servers automatically make available. If this function is not automatically available, then the application-specific code can itself produce this since all operations that affect the condition contain a conference key as additional parameter, which clearly identifies the particular condition.

The automatic conference management with component-oriented application servers is frequently realized by one component providing one component type. In addition the component provides one standardized service with which instances of this component type are produced and whose life cycle can be controlled. Each component instance possesses one condition of its own and can clearly be identified.

Examples of component-oriented application servers with automatic conference management are Enterprise JaveBeans and implementations of the CORBA component model. Web service platforms, on the other hand, are an example of component—oriented application services without an automatic conference management.

An application server, within a distributed application, only provides services that are used by client programs in the run time of the application. This requires that services are clearly referenced. Thus, a service reference must also contain, in a distributed application, the network address of the system that is offering the service. This network address, however, is typically different with each installation of a distributed application.

To date there have been three insufficient solutions for this problem in the art. One solution consists in firmly depositing in the client's code the references of the services that a client uses. Such a client program can be distributed and executed as desired in the network of the application server. Web service platforms in particular provide tools for producing the corresponding client code. Here the application server provides a description from which a code fragment is generated that becomes a firm component of the client. This solution makes possible a simple distribution of the client program, but requires considerable expense if the network addresses of the application server change, because in that way all references deposited in the client code are invalid. In this case the manual modification of the client's source code is required. The network address of the application server changes, for instance, by reason of maintenance tasks of restructurings in its network but it also changes if the distributed application is installed not just in one but also in other, additional networks.

An additional solution consists in the configuration of the client program for a concrete network. Here a persistent storage facility such as a configuration database is used which is entered and interpreted by the client program. This persistent storage facility contains the necessary information for referencing the services required by the client. With this solution, a modification of the source code by client programs is avoided, so that the expense for the adaptation of an application to a new installation in a network is reduced. Conversely, however, not just the actual client program but also the persistent storage facility must be distributed with the configuration data. This involves additional cost and makes more difficult the later maintainability of client. In particular, every persistent storage facility must be manually modified at some expense if the network address of the application server changes.

A third solution consists in the use of an indexing service. Thus in the network a standard service is available that storages references on application-specific services. The application server itself can also provide this standard service. The application-specific services offered by an application server are deposited in this standard service under a previously agreed key. With this network-independent key, a client can call up the network-dependent service reference from the standard service.

With this solution the problem is merely reduced, not solved. The reference of the standard service must in any case be made known to the client program in every installation of an application in a network. For this purpose, each of the two previously described solutions comes into use, but still has the aforementioned disadvantages.

### SUMMARY OF THE INVENTION

Accordingly, it is an object of the present invention to solve the problems arising in the art.

It is further an object of the present invention to provide a method and system by which a code is generated for the client that contains the necessary data, and, thus, by which the required services of the application server can be localized in a network.

It is also an object of the present invention to provide a method and system by which a client can easily be distributed over a network data file system such as is supported in standard manner by most modern operating systems and can be made available to client computers.

It is yet another object of the present invention to provide a method and system by which a hardware client can use the services provided by the run time environment after the production of the hardware from the generated hardware description as soon as it is connected to the network.

These and other objects of the present invention are achieved, in accordance with one embodiment of the present invention, by provision of a method for generating automatically distributable clients of application servers, characterized in that a code generator produces client programs that in an another, additional step can be automatically distributed to client computers or synthesized to hardware. The code generator resorts first to data known to it concerning the services provided by the application server and, second, to application-specific provided client code. Thus, a code fragment is generated and integrated into the client program that contains the necessary network address data in order to use the services of the application server or servers in the network. In developing the application-specific client code, placeholder code is used for this code fragment that is generated during the installation of the client.

In some embodiments, the code generator is formed as a part of the application server and uses the internal management data of the application server to generate the client program.

In some embodiments, the code generator receives the required data on the services offered in a network by one or more application servers through user input, description data files, or from other external sources.

In some embodiments, the placeholder code that is replaced by the code generator during the installation of the client only describes the interfaces of the later generated code.

In some embodiments, the code generated by the code generator contains exclusively network address data for the use of one or more index services.

In some embodiments, the application-specific client code is provided as components. In these embodiments, the code generator, like a component-oriented application server, produces middleware code for the individual components and connects this generated middleware code and the component code to a client program.

In some embodiments, the parts of a client that are independent of the concrete components are provided as prefabricated library. In these embodiments, the code generator merges this static run time environment into the client program, so that only the variable code part is regenerated with every installation of a client.

In accordance with another aspect of the present invention, a system for generating automatically distributable clients of application servers is provided, comprising a computer system, software executing on said computer system for implementing a code generator that produces client programs, and software executing on said computer system for automatically distributing client programs to client computers or synthesizing said programs to a hardware.

In some embodiments, the system further comprises the code generator that resorts first to data known to it concerning services provided by application server and, second, to an application-specific provided client code.

In some embodiments, the system further comprises a code fragment that is generated by said code generator and integrated into the client program, said code fragment containing necessary network address data in order to use the services of the application server in a network.

In some embodiments, the system further comprises software executing on said computer system for developing the application-specific client code using a placeholder code for the code fragment that is generated during an installation of a client.

In some embodiments, the code generator receives required data on services offered in a network by one or more application servers through user input, description data files, or from other external sources.

In some embodiments, the placeholder code is replaced by the code generator during the installation of the client and only describes interfaces of later generated code.

In some embodiments, the code generated by the code generator contains exclusively network address data for use of one or more index services.

In some embodiments, the system further comprises software executing on said computer system for providing the application-specific client code in form of components, software executing on said computer system for using the code generator to produce a middleware code for each said individual component, and software executing on said computer system for connecting said generated middleware code and the component code to the client program.

In some embodiments, the components of the application-specific code that are independent of concrete components are provided as a prefabricated library and are merged by the code generator into the client program so that only variable code parts are generated with every installation of the client.

In some embodiments, the system further comprises a substitute code fragment that matches said software.

In some embodiments, the system further comprises software executing on said computer system for implementing a code fragment for providing said prefabricated library.

The invention and its particular features and advantages will become more apparent from the following detailed description considered with reference to the accompanying drawings.

### BRIEF DESCRIPTION OF THE DRAWINGS

FIG. 1 is schematic view illustrating an application server known in the prior art.

FIG. 2 is a schematic view illustrating a component-oriented application server known in the prior art.

FIG. 3 is a schematic view illustrating the preferred embodiment of the present invention.

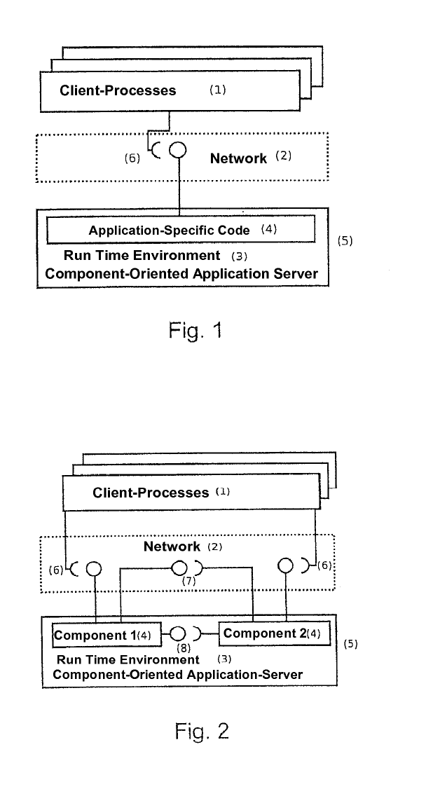

### DETAILED DESCRIPTION OF THE INVENTION

In the context of this invention, code is a description of information technology processes and data. Code refers in particular to data stored in a computer that as the operating instructions for this computer, as well as the structure of an electronic integrated circuit (application-specific electronics). In addition, all services that can definitely be modeled on one of these two forms of codes, or on combined forms of the same, are code.

A particular type of code is source code. This is a code that cannot be executed by direct mechanical means, but instead must be translated into other codes. Code that describes hardware is always source code, because it must first be converted into hardware.

A program in the sense of this invention is the totality of the code required to solve a concrete problem or a concrete class of problems. This can be for instance a software program that can be executed by a computer or a concrete electronic integrated circuit.

A process in the sense of this invention is a program that has just been worked out. It is for instance a software problem that is executed by a computer, or a concrete electronic integrated circuit that is supplied with energy and performs its specific task.

An application in the sense of this invention is the totality of the programs required to solve a quantity of logically connected tasks. A single user application such as word processing consists here of just one program. A distributed application consists of one or more programs, but during run time always consists of several processes working together.

A service in the sense of this invention is a particular, clearly defined service that makes a piece of code available to one or more other pieces of code. To fulfill the service usually requires the use of certain resources such as a numerical service and/or storage capacity.

An interface in the sense of this invention refers to a service. Thus it constitutes a binding agreement between the provider and the user of a service. Which parameters are stipulated by the interface for describing a service, depends on the individually applied technology for the concrete realization of the service.

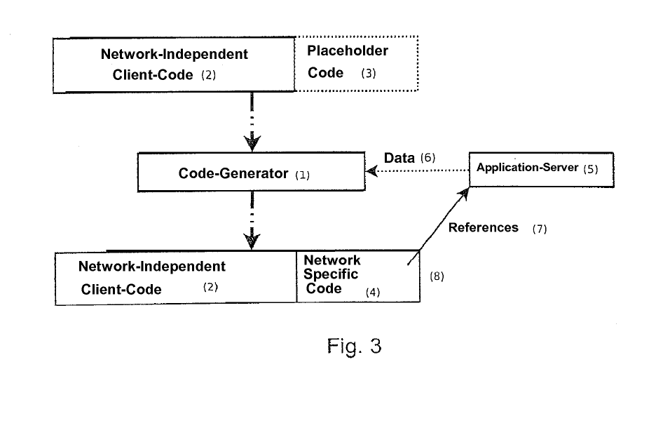

Referring to FIG. 3, the code fragment of the application service generates the actual client program only during the installation of the client. Thus this code generator (3.1) embeds in the code of the client program (3.8) the references (3.7) required by the client. In this manner there emerges a simply distributable client, which can also be transmitted automatically, for instance through a network database system, e-mail, or a similar available technology, to the client computers, where it can be started and executed in simple manner.

If the generated client program is a hardware description, then the hardware cannot be produced until after the description. Then this hardware can easily be connected to the network.

On the one hand, the code generator requires data (3.6) on the application server (3.5) and the services it provides. An advantageous embodiment of the invention therefore consists in producing the code generator as part of the application server. In this case, thanks to direct access to the internal management data of the application server, all necessary data are available to the code generator.

If the code generator is produced as an independent program, it receives the necessary data indirectly. Such an inventive installation program for clients receives the data, for instance, through the manual entry of data by a user. Another variant consists in the application server providing a description of the data, for instance in the form of a data file, which scans the installation program. Another inventive embodiment is the use of middleware for communication between the application server and the installation program for clients, where the application server provides the necessary data on a middleware interface. Further variants are possible for providing the necessary data to the installation program for clients.

Besides the network-specific data, the code generator requires the network-independent code of the client (3.2). In the development of this network-independent code, code is used as a placeholder (3.3) for the code produced by the generator. Both the code generator and the placeholder code that matches it are provided by an inventive realization of the process.

The placeholder code does not in itself provide any functionality, but merely serves to describe requirements to the code produced by the code generator during the installation of the client on a network, so that this generated code can replace the placeholder code. A possible inventive definition of these requirements can occur, for instance, through an interface description, which the network-independent code uses, and which is later provided by the generated network-specific code.

With this invention, the development of the client occurs independently from the concrete network in which the distributed application is later executed. An installation in various networks is therefore simple to achieve, because the source text of the client does not need to be adjusted. Only the installation program for clients, which an also be part of the application server, is required.

Also easy to realize is the adjustment to modifications to the services provided by the application server, for instance through maintenance tasks. The client program only needs to be regenerated. This can occur automatically if the client generator is part of the application server and is automatically started in case of modifications. The distribution of the client programs can also be automatic, for instance where they are published by means of a network data file system, or else are sent automatically to the users by e-mail.

An advantageous embodiment of the invention consists in the use of an index service. This service stores the concrete references that are used in the particular network. Therefore the generated network-specific code receives only the reference of the index service. Both the network-independent code and the code provided by the code generator can thus use the references of the user-specific services of the application server with the help of the index service.

This embodiment has several advantages. First, producing the code generator is simplified because the same code must always be generated in a concrete network. Only the reference of the particular index service must be correctly entered. Second, the client program needs to be regenerated only if the reference of the index service changes. If only the references of application-specific services change, then they are deposited in the index service. The client thus also uses the current references without a renewed generation.

An especially advantageous embodiment of the invention is realized in connection with component-oriented application servers. In this embodiment the code generator produces the client program using components. These components are dynamically loaded by application servers. If components are used for a client, the code generator produces code, which loads the components statically, that is automatically, at the start of the client program.

With this embodiment, a run time environment is required for the components; said environment, like the run time environment of the application server, produces the network communication of the components by middleware. This run time environment in this embodiment is likewise generated by the code generator, or is deposited with the client program by the code generator in the form of a prefabricated code fragment, for instance a software library.

Thus, with this embodiment, the continuous use of unit components is possible for the development of the entire use, because both the server and the client are composed of the same type of components Contrary to a server that executes instructions only when instructed by another program, a client necessarily defines a main control flow of its own, which controls the execution of the program. For this purpose an entry point into one of the components of the client—which defines the main control flow—is notified to the code generator.

In the following embodiment, the invention is implemented on the example of the CORBA component model. Here the code generator, which is part of the application server run time environment, from CORBA components produces a client program that can automatically use the services of the server.

CORBA components are combined into applications, so-called assemblies. One such assembly is described by an assembly descriptor, an SML data file. This XML data file contains data concerning which CORBA components belong to an assembly, on which run time environments these components should be installed in each time, which component instances should be produced in the initialization of the application, and how these are connected with one another.

The format of an assembly descriptor, as in most XML data files, is defined by the document type that establishes the allowed structure of the tags that describe the information. In this case the XML data file is broken down into the three sections—<component files>, <partitioning>m and <connections>—which each include further tags.

The first tag, <component files>, contains for every participating component a <component file> tag, which indicates the archive that contains the application-specific code and metadata of the component. Metadata are, for instance, the description of the interfaces of the component and license conditions.

The decisive second tag, <partitioning>, for the example production of the invention, defines secondary conditions for the installation of components. For each component to be installed, one <home placement> tag is indicated. If such a tag is indicated directly below the <partitioning> tag, then this component can be installed on any run time environment desired. In this way the components of an application can be distributed during the installation on various servers.

If several <home placement> tags are enclosed in a <host collocation> tag, then these components must all be installed on the same run time environment. If several <home placement> tags are enclosed in one <process collocation> tag, these components must all be executed in the same process. With a <host collocation> tag, the distribution of the components on various processes of the run time environment is free. Accordingly, several <process collocation> tags can also be enclosed by one <host collocation> tag.

At this point, in order to designate the components that belong to a client program, a new tag, <client collocation>, is introduced. This tag can be used like <process collocation>.

The code generator produces for CORBA components, which belong to a client program, the same infrastructure code as produced by the application server for the CORBA components executed by it. IN addition a client run time environment is available which provides services that are always required independently of the concrete components. From the generated infrastructure code, the client run time environment, and the components, the code generator produces a client program.

In contrast to the application server run time environment, which dynamically loads the component implementation and the generated infrastructure code when the component is installed, for the client program a main method is generated by the client generator that statically loads the participating components and the infrastructure code at the start of the client program. Here the tags, which are indicated inside a <home placement> tag, and which cause for instance the production of initial component instances or the registration of component instances with a name service, are configured in corresponding code fragments of the main method. These tags with the character of an instruction are otherwise dynamically interpreted by the run time environment during the installation of the component.

The tags of the third area tag <connections> describe the connections between the component instances. Thus they likewise have the character of instructions and are statically configured on code fragments for the main method.

Although the invention has been described with reference to a particular arrangement of parts, features and the like, these are not intended to exhaust all possible arrangements or features, and indeed many other modifications and variations will be ascertainable to those of skill in the art.

1. A method for generating automatically distributable clients of application servers, comprising the steps of:
producing client programs using a code generator;
automatically distributing said client programs to client computers;
wherein said code generator resorts first to data known to it concerning the services provided by the application server and, second, to an application-specific provided client code;
wherein a code fragment is generated by said code generator and integrated into the client program, said code fragment containing necessary network address data in order to use the services of the application server or servers in a the network; and
wherein, in developing the application-specific client code, a placeholder code is used for the code fragment that is generated during an installation of a client.

2. The method according to claim 1, wherein the code generator is formed as a part of the application server, enabling said code generator to use an internal management data of the application server to generate the client program.

3. The method according to claim 1, wherein said code generator receives required data on services offered in a network by one or more application servers through user input, description data files, or from other external sources.

4. The method according to claim 1, wherein said placeholder code is replaced by the code generator during the installation of the client and only describes interfaces of later generated code.

5. The method according to claim 1, wherein the code generated by the code generator contains exclusively network address data for use of one or more index services.

6. The method according to claim 1, further comprising the steps of:
providing the application-specific client code in form of components; and
using the code generator, to produces a middleware code for each said individual component and to connect said generated middleware code and the component code to the client program.

7. The method according to claim 6, wherein said components of the application-specific client code that are independent of concrete components are provided as a prefabricated library and are merged into the client program, so that only variable code parts are regenerated with every installation of the client.

8. A system for generating automatically distributable clients of application servers comprising:
a computer system;
software executing on said computer system for implementing a code generator that produce client to programs; and
software executing on said computer system for automatically distributing said client programs to client computers.

9-10. (canceled)

11. The system of claim 8, wherein said code generator resorts first to data known to it concerning services provided by application server and, second, to an application-specific provided client code.

12. The system of claim 8, wherein a code fragment is generated by said code generator and integrated into the client program, said code fragment containing necessary network address data in order to use the services of the application server in a network.

13. The system of claim 8 further comprising software executing on said computer system for developing the application-specific client code using a placeholder code for the code fragment that is generated during an installation of a client.

14. The system of claim 8, wherein the code generator receives required data on services offered in a network by one or more application servers through user input, description data files, or from other external sources.

15. The system of claim 8, wherein said placeholder code is replaced by the code generator during the installation of the client and only describes interfaces of later generated code.

16. The system of claim 8, wherein the code generated by the code generator contains exclusively network address data for use of one or more index services.

17. The system of claim 8 further comprising:
software executing on said computer system for providing the application-specific client code in form of components;
software executing on said computer system for using the code generator to produce a middleware code for each said individual component; and
software executing on said computer system for connecting said generated middleware code and the component code to the client program.

18. The system of claim 17, wherein said components of the application-specific code that are independent of concrete components are provided as a prefabricated library and are merged by the code generator into the client program so that only variable code parts are generated with every installation of the client.

19. The system of claim 8 further comprising a substitute code fragment that matches said software.

20. The system of claim 18 further comprising software executing on said computer system for implementing a code fragment for providing said prefabricated library.

21. A method for generating automatically distributable clients of application servers, comprising the steps of:
producing client programs using a code generator;
automatically synthesizing said programs to a hardware;
wherein said code generator resorts first to data known to it concerning services provided by the application server and, second, to an application-specific provided client code;
wherein a code fragment is generated by said code generator and integrated into the client program, said code fragment containing necessary network address data in order to use the services of the application server or servers in a network; and
wherein, in developing the application-specific client code, a placeholder code is used for the code fragment that is generated during an installation of a client.

22. A system for generating automatically distributable clients of application servers comprising:
a computer system;
software executing on said computer system for implementing a code generator that produces client programs; and
software executing on said computer system for automatically synthesizing said programs to a hardware.
